(19) United States
(12) Patent Application Publication
(10) Pub. No.: US 2025/0229449 A1
(43) Pub. Date: Jul. 17, 2025

(54) DEVICE FOR A BLADE CLEANING AND ITS DIMENSIONAL DETECTION IN CUTTING MACHINES

(71) Applicant: ATOM S.P.A., Vigevano (IT)

(72) Inventor: Riccardo DEAMBROSIS, Vigevano (IT)

(21) Appl. No.: 18/690,906

(22) PCT Filed: Aug. 31, 2022
(86) PCT No.: PCT/EP2022/025402

§ 371 Date: Mar. 11, 2024

(30) Foreign Application Priority Data
Sep. 13, 2021 (IT) 102021000023564

(51) Int. Cl. B26D 7/08

(52) U.S. Cl. CPC B26D 7/088

(57) ABSTRACT

A device for cleaning and dimensional detection of a blade of a cutting head of a cutting machine or cutting table, the blade being made of metal or other suitable material and selectively fixed to a side of an edge of a belt of the cutting machine or cutting table, the device comprising a first body provided with at least one compressed air blowing nozzle, and a seat extending into the first body so as to partially divide the first body into two sectors, each of the two sectors in turn being provided with a recess which is orthogonal with respect to said seat, and wherein at least part of the blade is selectively inserted into the seat whereupon the dimensional detection is provided thereon by an optical sensor arranged adjacent to the seat.

### CROSS-REFERENCE TO RELATED APPLICATION

This application claims priority to PCT application no. PCT/EP2022/025402, filed Aug. 31, 2022, which claims priority to Italian application no. IT 102021000023564, filed Sep. 13, 2021, the contents of which are incorporated by reference herein in their entireties.

### FIELD OF INVENTION

The present invention relates to a device for a blade cleaning and its dimensional detection in cutting machines. More in particular, the present invention relates to a device adapted to perform, automatically, the periodic cleaning and the detection of the height of the cutting blade in the machines which perform the cutting of various materials such as leather, hide, fabrics, synthetic, composites, expanded and technical materials to obtain semi-finished products having a pre-ordered shape; the material to be cut can also consist of two or more homogeneous layers or of different materials.

### BACKGROUND OF RELATED ART

As is known, in the industrial processing of footwear and leather goods and of the multiple items made starting from the aforementioned materials, specific machines are used which perform the preliminary cutting of the materials themselves to obtain the shaped semi-finished products. To cut the aforementioned materials, various types of machines are known, starting from the die-cutting machines provided with a swinging arm which is moved and operated by an operator. In the automatic continuous cutting systems of roll and sheet materials, cutting tables are currently widespread, which comprise an extensive work surface above which is generally arranged at least one beam bearing one or more blade cutting units; this type of machine also comprises equipment of the single arm type which can be angularly oriented.

In particular, although not exclusively referring to the so-called portal machines and continuous cutting tables, provided with one or more heads for as many blades, there is a need to periodically measure the height of the blade; this operation is firstly required whenever it is necessary to replace the blade itself, due to its wear or damage which affects the efficiency thereof.

In these cases, it is in fact necessary to redefine the zero of the reference system for cutting; this redefinition is traditionally done by hand, cutting out samples, for example of production waste, to identify the height of the blade. The height value is then manually changed within the software which manages the cutting system and this operation requires, as easily understood, much time for the operator, especially in work scenarios which require a frequent change of set-up, thus of the blade. Then there are other situations which require the verification of the integrity of the blade, which could be subject to breakage or damage due to the workloads and the type and features of the material to be cut; the integrity and the correct height of the blade ensure an optimal cutting quality, associated with a more homogeneous wear of the belt on which the material to be cut is lying. As a function of these needs, a periodic and constant check of the blade is performed, which generally involves the intervention of the operator. To measure the height of the blade, it is known to use a device comprising an optical sensor, which detects the status of the blade and indicates the need for any adjustments.

It has been found that this known device, designed and long used by the applicant, can only control the height of the blade and its conditions in general and therefore presents a significant drawback, in addition to the fact that it requires the systematic intervention of the operator. During the measurements, dust and processing slag are present on the blade, which can alter or at least make the detection performed by the optical sensor inaccurate, with the consequent risk of performing inadequate adjustments.

The object of the present invention is to remedy the problems lamented above, in particular relating to the presence of dust and slag on the blade before the measurements.

A blade cleaning device suitable for cutting a protective adhesive tape is known from US 2009 272403; the blade is inserted in a container in which a washing liquid is present.

More in particular, the object of the present invention is to provide a device capable of automatically and with extreme precision performing the dimensional detection of the blade in cutting machines, avoiding possible problems due to the presence of machining residues on the blade itself.

A further object of the invention is to provide a device adapted to automatically perform any adjustment in height of the blade following the result acquired through the detection of the optical sensor.

A not last object of the invention is to provide a device which allows to reduce the set-up times associated with the replacement of the blade or during the cutting cycle, while reducing the wear of the belt on which the material to be cut is arranged.

A further object of the invention is to provide users with a device for the blade cleaning and its dimensional detection in cutting machines adapted to ensure a high level of resistance and reliability over time, in addition such as to be easily and economically made.

### SUMMARY OF THE EMBODIMENTS

These and other objects are achieved by the device for a blade cleaning and its dimensional detection in cutting machines of the present invention according to the main claim in which a device (20, 20′) for the cleaning and dimensional detection of the blade (18) of the cutting heads (16) of cutting machines and tables (10), made of metal or other suitable material and intended to be fixed to the side of the edge (12′) of the belt (12) of a cutting table or machine (10), comprises at least a first body (32, 32′), provided with at least one compressed air blowing nozzle, and a seat (36) extended deep in the body itself and such as to partially divide it into two sectors (38, 40), in turn provided with a recess (42, 42′) which is orthogonal with respect to said seat (36) in which at least part of the blade (18) is inserted to perform the dimensional detection thereon through at least one optical sensor (44) arranged adjacent to the same seat (36).

In one aspect, the device (20) comprises a second body (30) placed adjacent to the first body (32), fixed thereto and to a base (22) at least in part hollow, and two blowing nozzles (24), (26) at least one of which communicates with said seat (36).

In another aspect, the device is characterized in that the recesses (42), (42)′ extended orthogonally with respect to said seat (36) accommodate the terminations (46) of the optical sensor (44).

In a further aspect, the device is characterized in that it comprises an element (33) at least in part hollow, fixed to the first body (32) and integrating the sensor body (44) with the relative cables, said element (33) being provided with longitudinally extended through holes (35) in which the screws for connection to said bodies (30) and (32) are inserted, as well as further exit holes (37) of the cables of the optical sensor (44).

In yet another aspect, the device is characterized in that the second body (30) comprises at least one brush (50), fixed or motorized, which protrudes upwards from the body itself in a position close to an opening (34) communicating with one of the blowing nozzles (24) or (26).

In a further aspect, the device (20) is characterized in that the compressed air is supplied into the base (22) through a duct (28), the blowing nozzles (24) and (26) extending developing vertically from holes (25) formed in the same base (22).

In still another aspect, the device is characterized in that the optical sensor cables (44) are housed in a seat (48) formed inside the bodies (30) and/or (32).

In another aspect, the device is characterized in that the sectors (38, 40) are removable and connected to the rest of the body (32′) by means of dovetail couplings (35) or equivalent means.

In yet another aspect, the device is characterized in that it interacts with a programmable controller (PLC) suitable for the operational management of the various functions of the cutting table or machine (10).

### BRIEF DESCRIPTION OF THE DRAWINGS

The construction and functional features of the device of the present invention will be more clearly comprehensible from the description below in which reference is made to the appended drawings which show a preferred and non-limiting embodiment and in which:

FIG. 1 depicts the device for a blade cleaning and its dimensional detection according to the invention applied, by way of example, to a continuous cutting table for cutting materials;

FIG. 2 schematically depicts an enlarged partial view of FIG. 1, in which a cutting head with the blade to be checked is visible;

FIG. 3 schematically depicts the device for a blade cleaning and its dimensional detection according to a first embodiment;

FIG. 3A schematically depicts the device for a blade cleaning and its dimensional detection according to a preferred embodiment;

FIG. 4 schematically depicts an exploded view of the device according to FIG. 3A;

FIG. 5 schematically depicts an exploded view of the device of the invention according to a first alternative embodiment;

FIG. 6 schematically depicts the assembled device of the invention in accordance with a second alternative embodiment;

FIG. 7 schematically represents a cutting head provided with a blade;

FIG. 8 schematically depicts the vertical blade movement spindle of the cutting head.

### DETAILED DESCRIPTION OF THE EMBODIMENTS

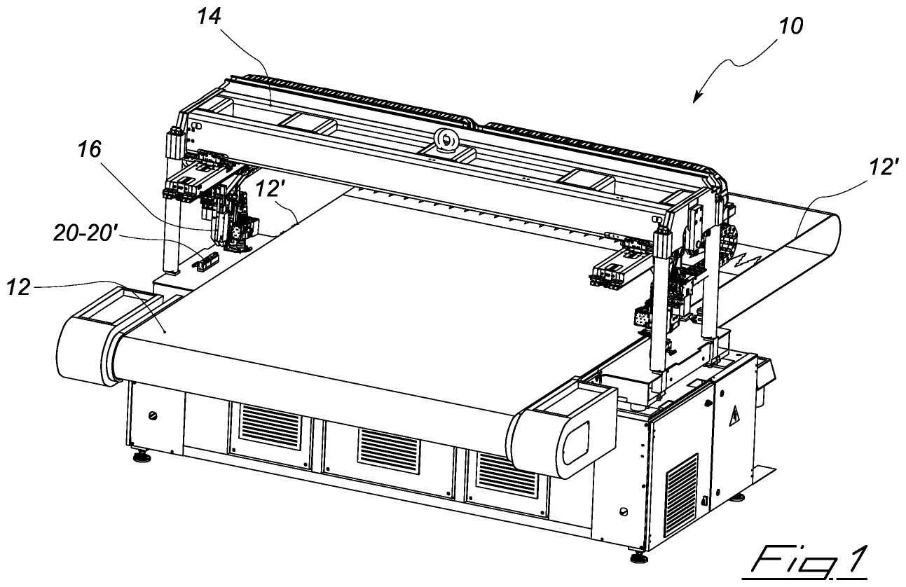

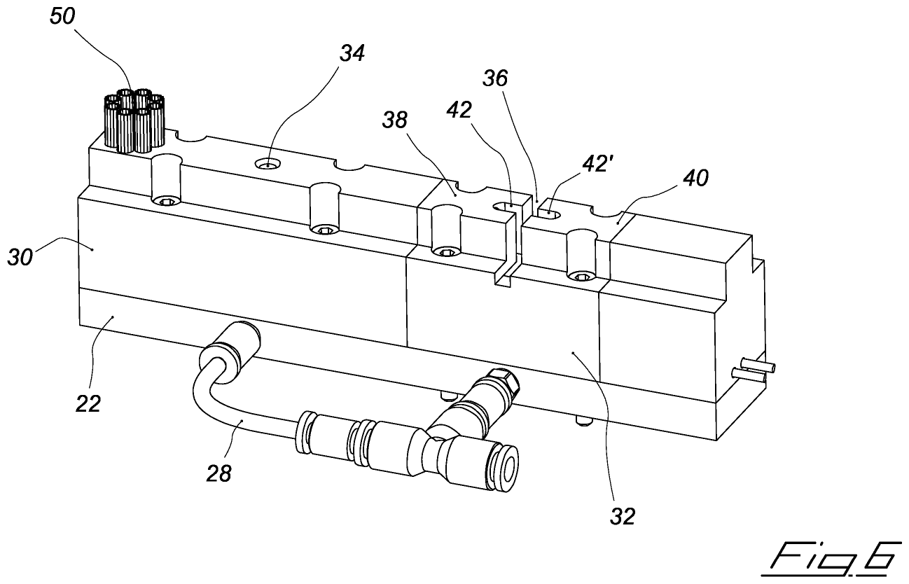

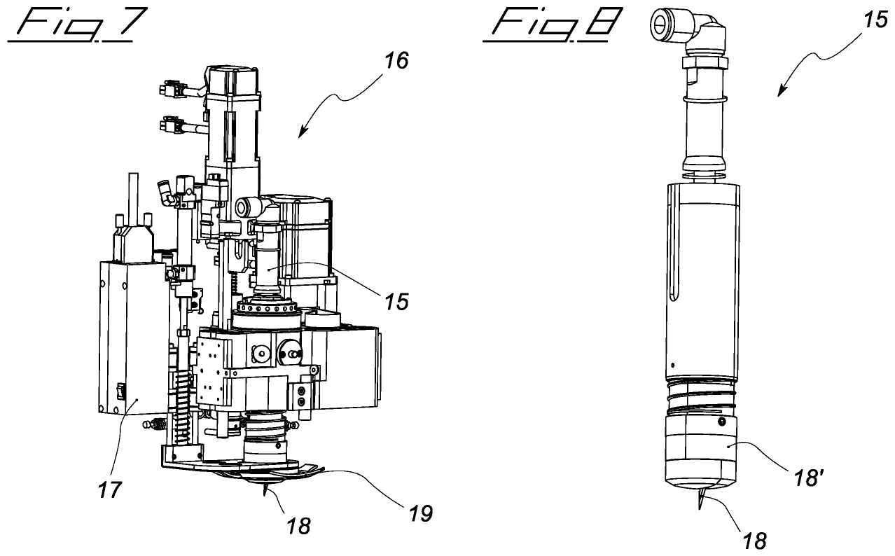

Reference is initially made to FIG. 1, which illustrates by way of example a cutting table, indicated as a whole with 10, adapted to be provided with the device of the invention; the cutting table 10, in itself known, comprises a belt 12 on which the material to be cut is lying and an overlying beam 14 which carries the cutting heads 16 (one of which is schematically shown in FIG. 7) with its blade 18. The device of the invention is positioned near the edge 12′ of the belt 12, so as to be reached by the cutting head 16; the latter comprises a pneumatic cylinder or the like, illustrated in FIG. 8 and indicated with 15, adapted to vertically move the blade 18 protruding from a cap 18′. The cutting head 16 further comprises movement means 17, in themselves known, for the vertical movement of a shaped plate 19 adapted to locally stabilize the material to be cut.

Said device is present on both opposite sides of the cutting table 10 if the latter is provided with two cutting heads 16.

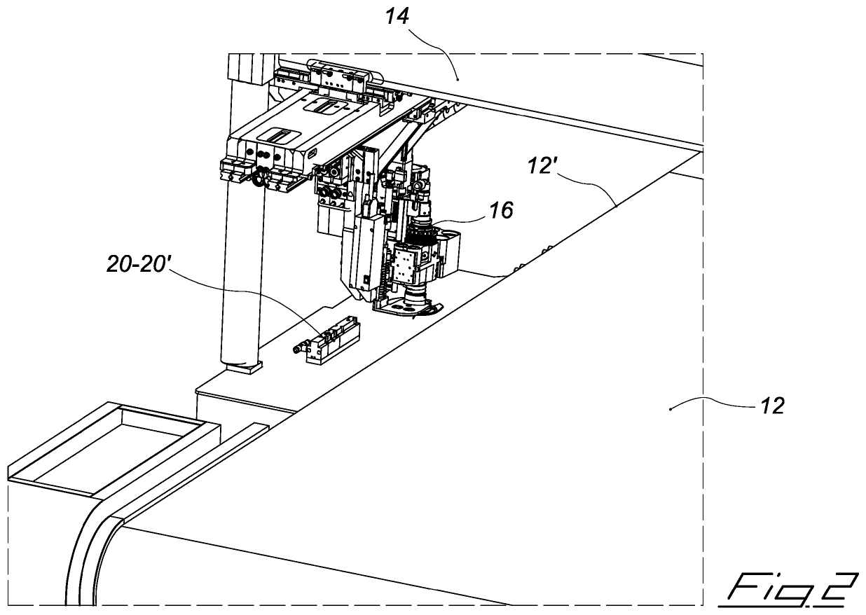

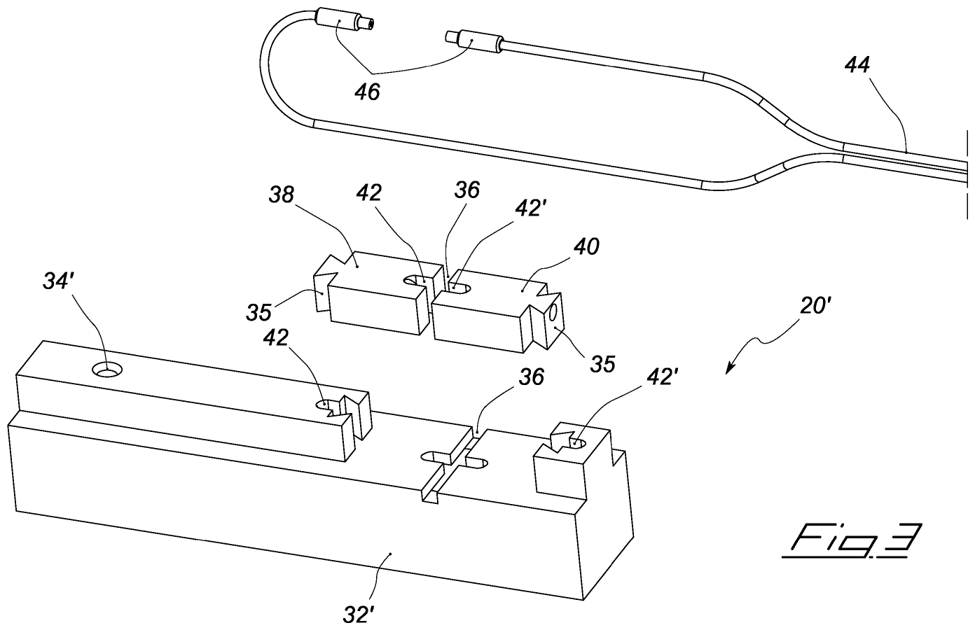

FIG. 3 illustrates the device of the invention, indicated overall with 20′, according to a first embodiment. Said device comprises a body 32′ with a rectangular plan, intended to be fixed with any suitable means to the cutting table (illustrated in FIGS. 1 and 2), next to the edge 12′ of the belt 12. A nozzle of the type known for blowing compressed air is connected directly or indirectly to the upper front of the body 32′; said nozzle is preferably inserted and fixed in a hole 34′ made in the body itself. The compressed air is supplied in a known manner in the hole 34′ in which the aforementioned nozzle is arranged. The body 32′ is open below to define an accessible cavity and is provided with a transverse milling 36 which extends deep into the body itself, partially dividing it into two sectors 38, 40; the latter are in turn provided with a recess 42, 42′ which is orthogonal with respect to the transverse milling 36. The recesses 42 and 42′ are intended to accommodate the terminations 46 of an optical sensor 44, inserted in the body 32′ starting preferably from its open lower front. In order to facilitate the positioning in the body 32′ of the terminations 46 of the optical sensor 44, it can however be envisaged that the sectors 38 and 40 are removable, their connection to the rest of the body 32′ being possible by means of dovetail couplings 35 or equivalent means.

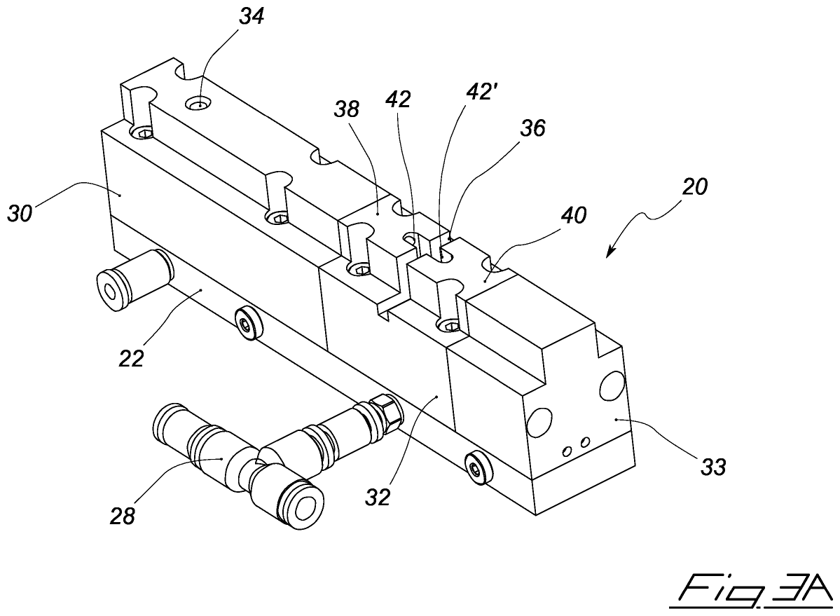

FIG. 3A shows the device of the invention according to a preferred embodiment and assembled in its components, which are instead separated from each other in the depiction of FIG. 4 for greater clarity of exposure. Said device comprises a base 22, at least in part hollow, on which is fixed, directly or indirectly through a conventional support, at least one nozzle, preferably two spaced nozzles 24, 26 for blowing compressed air, supplied through a suitable duct 28. The blowing nozzles 24 and 26 extend vertically from holes 25 formed in the base 22 and are inserted into the respective bodies 30, 32, the latter corresponding to the body 32′ of the previously described embodiment. The upper bodies 30 and 32 are constrained to each other and to the base itself with screws or equivalent retention means. The base 22 and the upper bodies 30, 32 or 32′ are made of casting metal or other suitable material, although the possibility of forming them by 3D printing is not excluded. One of the upper bodies, for example the second body 30, is provided with an opening 34 which communicates with the underlying nozzle 24 and from which an air flow exits; the first body 32 is instead provided, similarly to the body 32′ of the first embodiment described above, with a transverse milling 36 which extends deep in the body itself, partially dividing it into two sectors 38, 40, which in turn are provided with a recess 42, 42′ which is orthogonal with respect to the transverse milling 36. Also in this case, the terminations 46 of the optical sensor 44 are arranged in the recesses 42 and 42′, whose cables are advantageously housed in a seat formed inside the upper bodies 30, 32 and in part schematically shown with 48 in FIG. 4; the optical sensor 44 is connected to the programmable control device (PLC) that which manages the various functions of the cutting table 10.

The device 20 of the invention according to the preferred embodiment advantageously comprises, in addition to the bodies 30 and 32, a third element 33, fixed to the body 32 which accommodates the terminations 46 of the optical sensor 44. The element 33, at least in part hollow, performs the function of casing or cover of the body (not illustrated) of the sensor 44 and the relative cables; said element 33 is provided with through holes 35, extended longitudinally, in which the screws adapted to connect it to the bodies 30, 32, equally hollow, are inserted. Further holes 37 allow the exit of the optical sensor cables 44 from the element 33.

Given these structural features, the device of the present invention allows to verify the correct height dimension of the blade 18 carried by each cutting head 16 and, before that, advantageously allows to clean the blade itself, removing any machining residues therefrom. When the performance of the detection is requested, the cutting head 16 moved along the beam 14 is brought at the device 20, flanking it thereto from above; the blade 18 is conducted at or near the opening 34 or 34′ from which a blow, possibly repeated, of air exits which cleans the blade itself. Immediately after the head 16 is conducted to move to bring the blade 18 at the transverse milling 36 and to lower in steps to insert therein until the beam of the optical sensor 44 intercepts it; at this point, the measurement of the height of the blade begins, which occurs by slowly raising the blade itself and detecting/measuring the height at which said sensor is again free. In such a position, the blade is dimensionally checked by the optical sensor 44, which is in turn previously cleaned due to the air emitted by the blowing nozzle 26, positioned in the body 32 in line with the transverse milling 36. The terminations of the optical sensor 44 face the latter, abutted in the recesses 42, 42′ orthogonally oriented with respect to said transverse milling 36.

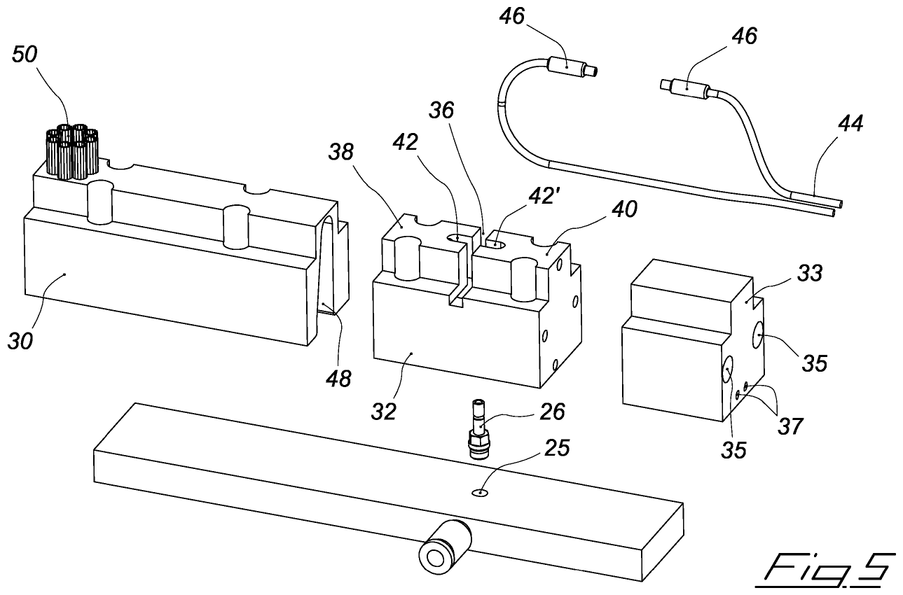

FIG. 6 illustrates a first alternative embodiment of the device of the invention in accordance with its preferred embodiment. In this case, the upper body 30 comprises at least one brush 50, which protrudes upwards from the body itself in a position close to the opening 34 communicating with the blowing nozzle 24; the brush 50 has the function of performing a cleaning operation on the blade 18, in addition to that carried out by means of the air emitted by the aforementioned nozzle 24. The brush 50 can be permanently fixed on the upper body 30 and, in this case, the cutting head 16 is conducted to move, which allows to remove from the blade 18, by means of abrasion, any processing residues present thereon; alternatively, the brush or brushes 50 can be moved in rotation by means of a micromotor (not illustrated) housed in the body 30.

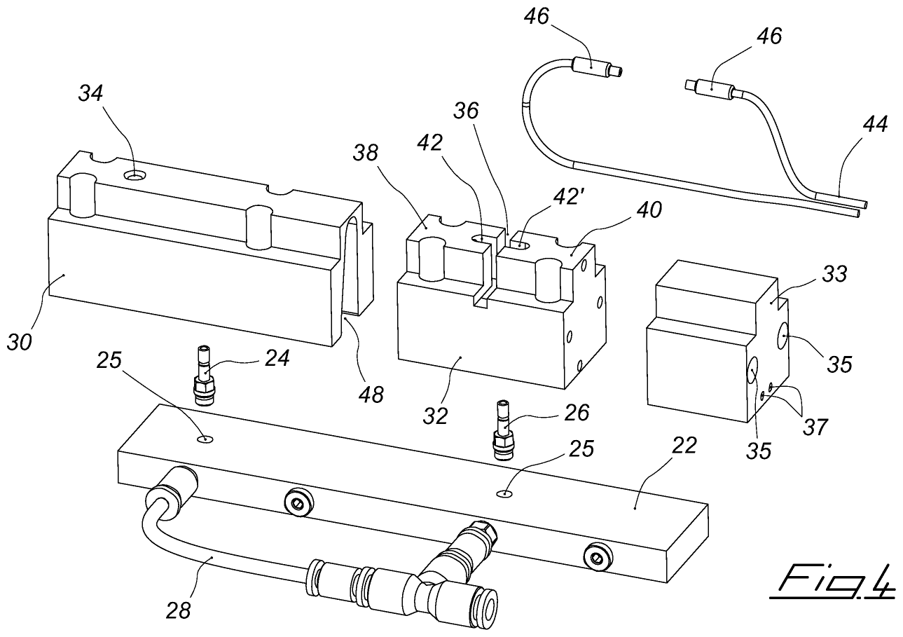

A second possible embodiment of the device according to the invention is instead illustrated in FIG. 5. In this hypothesis there is only one brush 50, while the blowing nozzle 24 is eliminated; the other nozzle 26 is instead responsible for cleaning the terminations 46 of the optical sensor 44.

The dimensional verification operations on the blade 18, the cleaning thereof and the terminations of the optical sensor are preferably programmed and timed, for example, as a function of the workloads, the production process, the type of material to be cut and the requirements requested by customers. In the control of the blade 18, two measurements are performed and compared at a distance of a given period of time; if variations in height are found between the two measurements, for example between 0.05-0.5 mm, they are considered as simple wear of the blade and the system dynamically updates the “zero” of the cutting reference by means of the PLC and the software with which the machine or the cutting table are provided. Higher variations indicate the probable damage or breakage of the blade 18; in this case the cutting system is automatically paused, pending the intervention of the operator who will restore it.

The device of the present invention allows to perform a particularly precise dimensional detection of the blade 18 of the cutting machines or tables, preceding such a detection by a careful cleaning to eliminate the processing residues from the blade itself. Said device allows to significantly reduce the set-up time associated with the blade change operation and, at the same time, reduces the wear of the cutting belt.

Further advantageous is the possibility of keeping the optical sensor 44 responsible for the measurements clean. The combination of the air emitted by the nozzles and the brush(es) 50 is also effective for a thorough cleaning of the device as a whole.

Although the present disclosure relates to an exemplary embodiment and to some alternatives, those skilled in the art will recognize that modifications and additions can be made to form and details without departing from the object of the claimed subject matter. For example, in relation to one or more features which offer one or more advantages, it is to be expected that they can be exchanged with each other or alternatively combined with each other in the exemplary embodiments or in other alternative embodiments. The present disclosure is manifestly intended to be as broad as possible whereby, in the absence of different specific annotations, claims comprising a single particular element also apply to a plurality of such particular elements.

What is claimed is:

1. A device (20, 20′) for cleaning and dimensional detection of a blade (18) of a first cutting head (16) of a cutting machine or cutting table, the blade being made of metal or other suitable material and selectively fixed to a side of an edge (12′) of a belt of the cutting machine or cutting table, the device comprising a first body provided with at least one compressed air blowing nozzle, and a seat (36) extending into the first body so as to partially divide the first body into two sectors (38, 40), each of the two sectors in turn being provided with a recess which is orthogonal with respect to said seat (36), and wherein at least part of the blade (18) is selectively inserted into the seat whereupon the dimensional detection is provided thereon by an optical sensor (44) arranged adjacent to the seat (36).

2. The device (20) according to claim 1, further comprising a second body (30) placed adjacent to the first body (32), fixed thereto and to a base (22) at least in part hollow, and two blowing nozzles (24), (26) at least one of which communicates with said seat (36).

3. The device according to claim 2, wherein each recess which is orthogonal with respect to said seat (36) is configured to accommodate a termination (46) of the optical sensor (44).

4. The device according to claim 1, further comprising an element (33) which is at least in part hollow, fixed to the first body (32) and arranged to integrate respective cables of the optical sensor, said element (33) being provided with longitudinally extended through holes (35) configured to receive screws for connection of the element to the first body, and exit holes (37) of configured to receive the respective cables of the optical sensor (44).

5. The device (20) according to claim 2, wherein the second body (30) comprises at least one brush (50), fixed or motorized, which protrudes upwards from the second body itself in a position close to an opening (34) communicating with one of the two blowing nozzles (24) or (26).

6. The device (20) according to claim 2, wherein compressed air is supplied into the base (22) through a duct (28), the two blowing nozzles (24) and (26) extending vertically from holes (25) formed in the base (22).

7. The device (20) according to claim 2, wherein cables of the optical sensor are housed in a seat (48) formed inside at least one of the first body and/or (32) the second body.

8. The device (20′) according to claim 1, wherein the two sectors (38, 40) are removable and connected to the first body (32′) by couplings (35).

9. The device according to claim 1, further comprising a programmable controller configured and arranged for executing one or more functional operations of the cutting table or cutting machine (10).

10. The device according to claim 1, further comprising a second cutting head having a second blade, the second cutting head being positioned on an opposite side of the first cutting head and the belt of the cutting machine or cutting table.
